(19) United States
(12) Patent Application Publication
(10) Pub. No.: US 2023/0325421 A1
(43) Pub. Date: Oct. 12, 2023

(54) Selecting from Arrays of Multilingual Content

(71) Applicant: GOOGLE LLC, Mountain View, CA (US)

(72) Inventors: Prajakta Suresh Kalekar, Mountain View, CA (US); Qiang Fu, Mountain View, CA (US); Meghendra Madhusudan Umekar, Mountain View, CA (US)

(21) Appl. No.: 18/022,260

(22) PCT Filed: Jul. 21, 2021
(86) PCT No.: PCT/US2021/042614

§ 371 Date: Feb. 20, 2023

(30) Foreign Application Priority Data
Aug. 20, 2020 (WO) PCT/US2020/047193

(51) Int. Cl. G06F 16/33; G06F 16/9537; G06F 40/263; G06F 40/40

(52) U.S. Cl. CPC G06F 16/3337; G06F 16/9537; G06F 40/263; G06F 40/40

(57) ABSTRACT

Systems and methods of selecting content to provide in networked environments are provided herein. A data processing system can receive an input from a client device, the input including keywords in a first language. The data processing system can determine the first language based on the keywords of the input. The data processing system can determine, using the input, a location identifier identifying a location of the client device. The data processing system can identify a second language associated with the location identifier. The data processing system can identify a first plurality of content items in the first language and a second plurality of content items in the second language based on the input. The data processing system can provide, to the client device, a content item from one of the first plurality of content items and the second plurality of content items.

### CROSS REFERENCE TO RELATED APPLICATIONS

The present application claims the benefits of and priority to International Patent Application No. PCT/US2020/047193, titled “Selecting from Arrays of Multilingual Content,” filed Aug. 20, 2020, which is incorporated herein by reference in its entirety.

### BACKGROUND

In computer networked environments such as the Internet, content providers can provide content items to be inserted into an information resource (e.g., a webpage) processed and rendered by an application (e.g., a web browser) executing on a client device.

### SUMMARY

At least one aspect is directed to a method of selecting content to provide in networked environments. A data processing system having one or more processors can receive an input from a client device, the input including one or more keywords in a first language. The data processing system can determine the first language based on the one or more keywords of the input. The data processing system can determine, using the input, a location identifier identifying a location of the client device. The data processing system can identify a second language associated with the location identifier. The second language can differ from the first language. The data processing system can identify a first plurality of content items in the first language and a second plurality of content items in the second language based on the input. The data processing system can provide, to the client device, a content item from one of the first plurality of content items and the second plurality of content items.

In some implementations, the data processing system can identify a second input from the client device. The second input can include one or more second keywords in accordance with the second language. In some implementations, the data processing system can determine, based on the one or more keywords of the input and the one or more second keywords of the second input, that the client device uses the first language and the second language. In some implementations, identifying the second plurality of content items can include identifying the second plurality of content items responsive to determining that the client device uses the first language and the second language.

In some implementations, the data processing system can generate, responsive to determining that the client device uses the first language and the second language, one or more second keywords in the second language based on the one or more keywords in the first language. In some implementations, identifying the first plurality of content items can include identifying the first plurality of content items using the one or more keywords in the first language. In some implementations, identifying the second plurality of content items can include identifying the second plurality of content items using the one or more second keywords in the second language.

In some implementations, the data processing system can identify a plurality of inputs from a plurality of client devices, each of the plurality of inputs having one or more second keywords in the second language. Each of the plurality of client devices can be associated with the location identifier corresponding to the location identifier for the client device. In some implementations, identifying the second language as associated with the location identifier can include determining the second language based on the one or more second keywords from each of the plurality of inputs.

In some implementations, the data processing system can determine that the first language determined from the one or more keywords of the input differs from the second language associated with the location identifier of the input. In some implementations, identifying the first plurality of the content items and the second plurality of content items can include identifying the first plurality of the content items and the second plurality of content items responsive to determining that the first language differs from the second language.

In some implementations, the data processing system can generate a selection value for each content item of the plurality of first content items and the second plurality of content items based on comparison of a language of the content item and the first language determined from the query. In some implementations, the data processing system can select the content item from the first plurality of content items and the second plurality of content items based on a corresponding plurality of selection values in accordance with a content selection protocol.

In some implementations, the data processing system can determine, using a log record for the client device, a first interaction rate with content items in the first language and a second interaction rate with content items in the second language. In some implementations, the data processing system can generate a selection value for each content item of the plurality of first content items and the second plurality of content items based on at least one of the first interaction rate and the second interaction rate. In some implementations, the data processing system can select the content item from the first plurality of content items and the second plurality of content items based on a corresponding plurality of selection values in accordance with a content selection protocol.

In some implementations, receiving the input can include receiving a query via a search engine accessed via an application executing on the client device, the query including one or more keywords. In some implementations, providing the content item can include providing the content item for presentation via the application executing on the client device subsequent to receipt of the query.

In some implementations, the data processing system can receive a second input from a second client device, the second input identifying one or more second keywords in the first language, the second client device associated with the location identifier. In some implementations, the data processing system can determine that the second client device uses the first language and does not use the second language identified as associated with the location identifier based on a plurality of inputs from the second client device. In some implementations, the data processing system can identify a third plurality of content items in the first language without any content items in the second language.

In some implementations, the data processing system can receive, prior to the input, a second input from the client device. The second input can include one or more second keywords in the second language. In some implementations, the data processing system can determine the second language based on the one or more second keywords. In some implementations, the data processing system can provide, responsive to determining that the second language, a third plurality of content items in the second language without identifying any content items in the first language.

At least one aspect is directed to a system for selecting content to provide in networked environments. The system can include a data processing system having one or more processors coupled with memory. The data processing system can receive an input from a client device, the input including one or more keywords in a first language. The data processing system can determine the first language based on the one or more keywords of the input. The data processing system can determine, using the input, a location identifier identifying a location of the client device. The data processing system can identify a second language associated with the location identifier. The second language can differ from the first language. The data processing system can identify a first plurality of content items in the first language and a second plurality of content items in the second language based on the input. The data processing system can provide, to the client device, a content item from one of the first plurality of content items and the second plurality of content items.

In some implementations, the data processing system can identify a second input from the client device. The second input can include one or more second keywords in accordance with the second language. In some implementations, the data processing system can determine, based on the one or more keywords of the input and the one or more second keywords of the second input, that the client device uses the first language and the second language. In some implementations, the data processing system can identify the second plurality of content items responsive to determining that the client device uses the first language and the second language.

In some implementations, the data processing system can generate, responsive to determining that the client device uses the first language and the second language, one or more second keywords in the second language based on the one or more keywords in the first language. In some implementations, the data processing system can identify the first plurality of content items using the one or more keywords in the first language. In some implementations, identifying the second plurality of content items can include identifying the second plurality of content items using the one or more second keywords in the second language.

In some implementations, the data processing system can identify a plurality of inputs from a plurality of client devices, each of the plurality of inputs having one or more second keywords in the second language. Each of the plurality of client devices can be associated with the location identifier corresponding to the location identifier for the client device. In some implementations, the data processing system can determine the second language based on the one or more second keywords from each of the plurality of inputs.

In some implementations, the data processing system can determine that the first language determined from the one or more keywords of the input differs from the second language associated with the location identifier of the input. In some implementations, the data processing system can identify the first plurality of the content items and the second plurality of content items responsive to determining that the first language differs from the second language.

In some implementations, the data processing system can generate a selection value for each content item of the plurality of first content items and the second plurality of content items based on comparison of a language of the content item and the first language determined from the query. In some implementations, the data processing system can select the content item from the first plurality of content items and the second plurality of content items based on a corresponding plurality of selection values in accordance with a content selection protocol.

In some implementations, the data processing system can determine, using a log record for the client device, a first interaction rate with content items in the first language and a second interaction rate with content items in the second language. In some implementations, the data processing system can generate a selection value for each content item of the plurality of first content items and the second plurality of content items based on at least one of the first interaction rate and the second interaction rate. In some implementations, the data processing system can select the content item from the first plurality of content items and the second plurality of content items based on a corresponding plurality of selection values in accordance with a content selection protocol.

In some implementations, the data processing system can receive a query via a search engine accessed via an application executing on the client device, the query including one or more keywords. In some implementations, the data processing system can provide the content item for presentation via the application executing on the client device subsequent to receipt of the query.

In some implementations, the data processing system can receive a second input from a second client device, the second input identifying one or more second keywords in the first language, the second client device associated with the location identifier. In some implementations, the data processing system can determine that the second client device uses the first language and does not use the second language identified as associated with the location identifier based on a plurality of inputs from the second client device. In some implementations, the data processing system can identify a third plurality of content items in the first language without any content items in the second language.

In some implementations, the data processing system can receive, prior to the input, a second input from the client device. The second input can include one or more second keywords in the second language. In some implementations, the data processing system can determine the second language based on the one or more second keywords. In some implementations, the data processing system can provide, responsive to determining the second language, a third plurality of content items in the second language without identifying any content items in the first language.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting a system for selecting content to provide in networked environments, according to an illustrative implementation;

FIG. 2 is a block diagram depicting a query handling phase of the system for selecting content to provide in networked environments, according to an illustrative implementation;

FIG. 3 is a block diagram depicting a location identification phase of the system for selecting content to provide in networked environments, according to an illustrative implementation;

FIG. 4 is a block diagram depicting a keyword translation phase of the system for selecting content to provide in networked environments, according to an illustrative implementation;

FIG. 5 is a block diagram depicting a content item aggregation phase of the system for selecting content to provide in networked environments, according to an illustrative implementation;

FIG. 6 is a block diagram depicting a content selection phase of the system for selecting content to provide in networked environments, according to an illustrative implementation;

FIG. 7 is a flow diagram depicting a method of selecting content to provide in networked environments, according to an illustrative implementation; and

FIG. 8 is a block diagram illustrating a general architecture for a computer system that may be employed to implement elements of the systems and methods described and illustrated herein, according to an illustrative implementation.

### DETAILED DESCRIPTION

Following below are more detailed descriptions of various concepts related to, and implementations of, methods, apparatuses, and systems of selecting content to provide in networked environments. The various concepts introduced above and discussed in greater detail below may be implemented in any of numerous ways, as the described concepts are not limited to any particular manner of implementation.

In content distribution platforms, a centralized service can select content items from various content providers to distribute to client devices using a multitude of selection parameters. The content items may have been generated to include audio, video, or textual content in one particular language (e.g., English). The selection parameters for each content item may be set by the respective content provider to define that the content item is to be provided to a client device when associated with a specific language identifier. For example, a request for content or query from a client device can identify that the language used by the associated account is Spanish. In addition, the account profile associated with the client device submitting the request can be set to identify the user's language is Spanish. Based on the identifier, the service can select and provide one of the content items with textual content in Spanish with a selection parameter that also indicates Spanish.

One shortcoming with selecting content items in this manner may be that this approach may not take into account that the user of the recipient client device may be multi-lingual (e.g., English and Spanish). This omission may be especially true with users that use a language that differs from the dominant language associated with the geographical region that the user is in, as such users would likely know both the non-dominant and dominant languages. The oversight may be further exacerbated by the fact that many users do not self-report which languages they know in their account profiles. Under the approach, the set of candidate content items for such users may be identified from one language (e.g., Spanish), thus precluding the content items in other languages that the user might be comfortable or fluent in (e.g., English). The exclusion of such content items from selection may lead to greater consumption of computing and network resources, as the user may make additional queries to find relevant content via the client device. In addition, the ruling out of content items from other language may also result in lower quality of human-computer interaction (HCl) between the user and the client device, because the content may only be in one language but not in other languages that the user is familiar with.

To account for these and other technical challenges, the service of the content distribution platform can expand the set of candidate content items from which to select to include content items from multiple languages that the user is identified as using. To that end, the service (also referred herein as a data processing system) can parse a query originating from the client device associated with the account of the user to identify a language that the query is in. The service can also parse the query to identify a geographic region (or location identifier) of the client device from which the query is sent. The geographic region may be identified as associated with a dominant language based on parsing of queries from other client devices from the same region. For example, for the geographic regions of Austria, Germany, and Switzerland, the dominant language may be marked as German based on the fact that other queries from such countries are in German. Using the labeling for the geographic region, the service may identify the associated dominant language.

With these identifications, the service can compare the language from the query of the individual client device and the dominant language of the geographic region. When the languages differ, the service may determine whether the user of the client device understands the dominant language by analyzing previous queries or activities from the client device. In this fashion, rather than using the languages identified in the account profile of the user, the service can objectively determine which languages the user uses from the queries or previous activities. The service may parse the queries to identify the language that the queries are in. When the language from the other queries matches the dominant language, the service may determine that the user understands the dominant language in addition to the language identified from the current query.

Based on the determination, the service can translate the current query from the original language to the dominant language using a machine translation model. Using the query in both the original language and the dominant language, the service can find content items with matching selection parameters. For example, the query may have originally been “usados carros” in Spanish and translated to “used cars” in English. Using the query in both languages, the service may find content items with keywords “used cars” in English and “usados carros” in Spanish. Once the content items are identified, the service can run a content selection process to select a content item to provide to the client device. This can result in the selection of a content item in a language different from the original language of the query. For instance, the client device may have sent a query in English from Canada, but the user may be determined to know English and French. From the content selection process, the service may select a content item in French despite the fact that the language of the current query is in English.

In this manner, the set of content items from which to select and provide may be expanded to include multiple languages. The inclusion of these content items for selection may lead to a decreased consumption of computing and network resources, with the user making less queries to find relevant content via the client device. Reducing the number of queries needed to provide a desired result can reduce processing, battery and/or bandwidth requirements of one or more of a client device, data processing system, content provider, content publisher and network. In particular, the processing, battery and/or bandwidth requirements associated with one or more of inputting queries, transmitting queries, generating responses to queries, transmitting responses to queries and displaying responses to queries may be reduced. Avoiding the need to transmit multiple queries and responses lowers bandwidth requirements and eliminates computational overheads associated with multiple transmissions of queries and responses. Moreover, through determining if and when content can be provided in more than one language, for example by harnessing location data and/or previous inputs associated with one or more client devices, the unnecessary translation of content can be avoided. The additional processor requirements associated with translating content can thereby be utilized only when they are required, resulting in more optimized utilization of available computational resources. Therefore, the described techniques provide more efficient selection of content to provide in networked environments.

Furthermore, the addition of content items across multiple languages may result in higher quality of HCl between the user and the client device, as the content may be in any of the languages that the user is determined to know. The described techniques enable selection of a content item to provide from an expanded range of content items, which can be provided based on location data and/or previous inputs associated with one or more client devices. The described techniques thereby enable more accurate selection and provision of content in networked environments to be achieved.

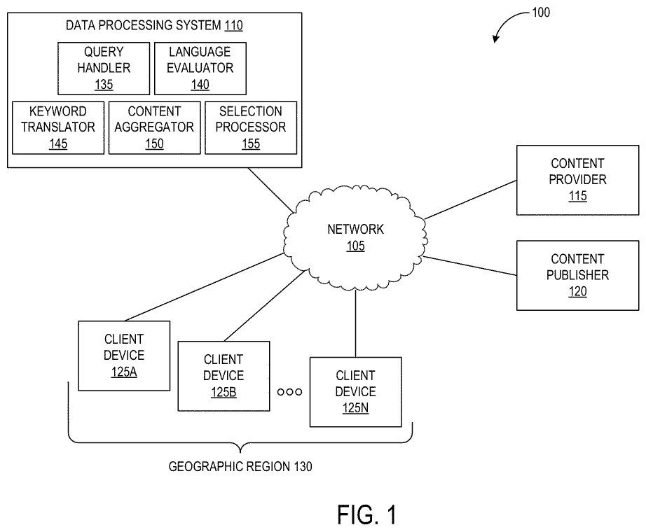

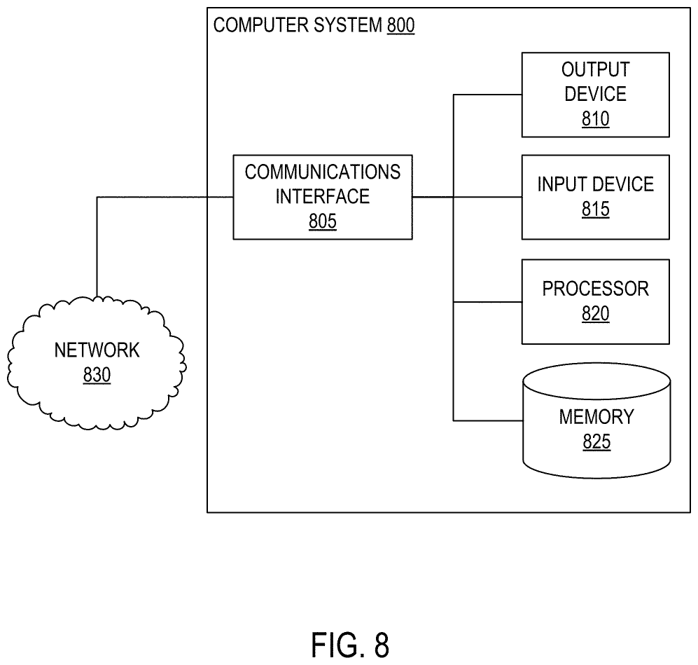

Referring now to FIG. 1, depicted is a block diagram depicting one implementation of a computer networked environment or a system 100 for selecting content to provide. In overview, the system 100 can include at least one network 105 for communication among the components of the system 100. The system 100 can include at least one data processing system 110 to handle requests communicated via the network 105. The data processing system 110 can include at least one query handler 135, at least one language evaluator 140, at least one keyword translator 145, at least one content aggregator 150, and at least one selection processor 155, among others. The system 100 can include at least one content provider 115 to provide content items. The system 100 can include at least one content publisher 120 to provide information resources (e.g., webpages). The system 100 can include one or more client devices 125A-N (hereinafter generally referred to as client device 125) associated with at least one geographic region 130 to communicate via the network 105. Each of the components (e.g., the network 105, the data processing system 110 and its components, the content provider 115 and its components, the content publisher 120 and its components, and the client device 125 and its components) of the system 100 can be implemented using the components of a computing system 800 detailed herein in conjunction with FIG. 8.

In further detail, the network 105 of the system 100 can communicatively couple the data processing system 110, the content provider 115, the content publisher 120, and the client devices 125 with one another. The data processing system 110, the content provider 115, and the content publisher 120 of the system 100 each can include a plurality of servers located in at least one data center or server farm communicatively coupled with one another via the network 105. The data processing system 110 can communicate via the network 105 with the content provider 115, the content publisher 120, and the client devices 125. The content provider 115 can communicate via the network 105 with the data processing system 110, the content publisher 120, and the client devices 125. The content publisher 120 can communicate via the network 105 with the data processing system 110, the content publisher 120, and the client devices 125. The client device 125 can communicate via the network 105 with the data processing system 110, the content provider 115, and the content publisher 120.

The content provider 115 can include servers or other computing devices operated by a content provider entity to provide content items for display on information resources at the client device 125. The content provided by the content provider 115 can take any convenient form. For example, the third-party content may include content related to other displayed content and may be, for example, pages of a website that are related to displayed content. The content may include third party content items or creatives (e.g., ads) for display on information resources, such as an information resource including primary content provided by the content publisher 120. The content items can also be displayed on a search results web page. For instance, the content provider 115 can provide or be the source of content items for display in content slots (e.g., inline frame elements) of the information resource, such as a web page of a company where the primary content of the web page is provided by the company, or for display on a search results landing page provided by a search engine. The content items associated with the content provider 115 can be displayed on information resources besides webpages, such as content displayed as part of the execution of an application on a smartphone or other client device 125.

The content publisher 120 can include servers or other computing devices operated by a content publishing entity to provide information resources including primary content for display via the network 105. For instance, the content publisher 120 can include a web page operator who provides primary content for display on the information resource. The information resource can include content other than that provided by the content publisher 120, and the information resource can include content slots configured for the display of content items from the content provider 115. For instance, the content publisher 120 can operate the website of a company and can provide content about that company for display on web pages of the website. The web pages can include content slots configured for the display of content items provided by the content provider 115 or by the content publisher 120 itself. In some implementations, the content publisher 120 includes a search engine computing device (e.g. server) of a search engine operator that operates a search engine website. The primary content of search engine web pages (e.g., a results or landing web page) can include results of a search as well as third party content items displayed in content slots of the information resource such as content items from the content provider 115. In some implementations, the content publisher 120 can include one or more servers for providing video content.

The data processing system 110 can include servers or other computing devices operated by a content placement entity to select or identify content items to insert into the content slots of information resources via the network 105. In some implementations, the data processing system 110 can include a content placement system (e.g., an online ad server). The data processing system 110 can maintain an inventory of content items to select from to provide over the network 105 for insertion into content slots of information resources. The inventory may be maintained on a database accessible to the data processing system 110. The content items or identifiers to the content items (e.g., addresses) can be provided by the content provider 115.

Each client device 125 can include a computing device to communicate via the network 105 to display data. The displayed data can include the content provided by the content publisher 120 (e.g., the information resource) and the content provided by the content provider 115 (e.g., the content item for display in a content slot of the information resource) as identified by the data processing system 110. The client device 125 can include desktop computers, laptop computers, tablet computers, smartphones, personal digital assistants, mobile devices, consumer computing devices, servers, clients, digital video recorders, a set-top box for a television, a video game console, or any other computing device configured to communicate via the network 105.

One or more of the client devices 125 can be located or otherwise associated with the geographic region 130. The geographic region 130 can correspond to or include any physical or network location. For example, the geographic region 130 can correspond to a physical area, such as a city, a township, a village, a county, a zip code, a canton, a community, a district, a province, a state, a parish, a prefecture, a country, or any other form of an administrative division, among others. The physical area corresponding to the geographic region 130 can be associated with particular sets of network addresses (e.g., IP addresses) used by client devices 125 in accessing the network 105.

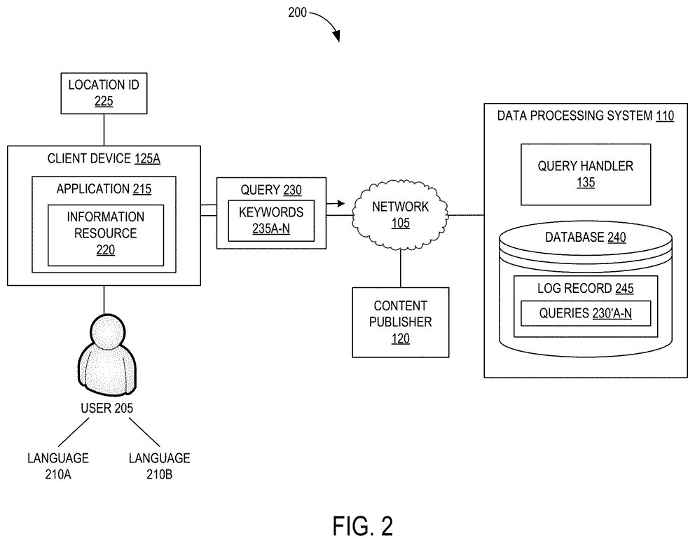

Referring now to FIG. 2, depicted is a block diagram of a query handling phase 200 of the system 100 for selecting content to provide in networked environments, according to an illustrative implementation. As depicted, a client device 125A can be operated or used (e.g., using input/output (I/O) devices) by at least one user 205. In some implementations, the user 205 can be associated with the client device 125A (e.g., via an account to login into the client device 125A). The user 205 can be proficient in or can understand multiple languages, such as a first language 210A and a second language 210B (hereinafter generally referred to as language 210). The language 210 can include any natural language, such as English, Spanish, French, German, Mandarin, Hindu-Urdu, Arabic, Russian, Portuguese, Japanese, Korean, Indonesian, and Italian, among others. The language 210 can be represented textually (e.g., using symbols). In the geographic region 130, the first language 210A can be a non-dominant language and the second language 210B can be a dominant language. Alternatively, the user 205 may also be proficient in or understand one language, such as either the first language 210A or the second language 210B.

The client device 125A (and each of the other client devices 125) can execute or include at least one application 215. The application 215 can be a program executable on the client device 125A to access resources via the network 105. For example, the application 215 can be a web browser, a web application, a mobile application, or a word processing application, among others. In some implementations, the application 215 can fetch at least one information resource 220 (e.g., a webpage) from the content publisher 120. With the user 205 interacting with the application 215, the client device 125A can receive inputs (e.g., text or audio signal) in the first language 210A or in the second language 210B. In addition, the client device 125A (or the application 215) can be associated with at least one location identifier 225. The location identifier 225 can identify a location of the client device 125A. The location identifier 225 can indirectly correspond to or reference the geographic region 130, and can be a network address (e.g., an Internet Protocol (IP) address or a media access control (MAC) address). The location identifier 225 can directly correspond to or reference the geographic region 130, and can be a geographic address (e.g., global positioning system (GPS) coordinates or a set of alphanumeric characters).

The application 215 executing on the client device 125A can generate and transmit at least one query 230 (or a request for content or some form of an input) to the data processing system 110 over the network 105. The query 230 can identify or include one or more keywords 235A-N (hereinafter generally referred to as keywords 235). The generation and transmission of the query 230 can be in response to an input by the user 205 via the application 215 (e.g., a user element) running on the client device 125A. In some implementations, the generation and transmission of the query 230 can be in response to an execution of a script on the information resource 220. The script may be for a request for content to include onto a content slot of the information resource 220. In some implementations, the query 230 can also identify or include the location identifier 225 associated with the client device 125A. In some implementations, the query 230 can include other metadata besides the location identifier 225, such as: a timestamp corresponding to a time at which the query 230 is generated or transmitted, an account identifier corresponding to an account used by the user 205, an application identifier referencing the application 215, an identifier (e.g., a URL) for the source resource referencing the information resource 220, a client identifier (e.g., a network address or session identifier) for the client device 125A, among others. In some implementations, the query 230 can correspond to a request for content, and can identify or include an identifier (e.g., a Uniform Resource Locator (URL)) for a requested resource as part of the metadata. Upon receipt of the input, the application 215 can generate the query 230 to identify or include the keywords 235. With the generation, the application 215 can send, provide, or otherwise transmit the query 230 to the data processing system 110 via the network 105.

The input for the keywords 235 of the query 230 can be performed via one of the I/O devices of the client device 125A. In some implementations, the input can be a textual input made via a keyboard or a touchscreen of the client device 125A. The one or more keywords 235 of the query 230 can correspond to or include sets of alphanumeric characters in textual input. In some implementations, the keywords 235 of the query 230 can correspond to the input on an element of the information resource 220 (e.g., a search engine). In some implementations, the input can be an audio input made via a microphone or another form of a transducer for audio input. The one or more keywords 235 of the query 230 can correspond to portions of the audio input corresponding to sets of alphanumeric characters. In some implementations, the application 215 can convert the input audio into sets of alphanumeric characters (e.g., text) to include as keywords 235 of the query 230 using natural language processing (NLP) techniques (e.g., speech recognition). In some implementations, the input audio can be included in the query 230 to be converted to the sets of alphanumeric characters at the data processing system 110.

The query handler 135 executing on the data processing system 110 can retrieve, identify, or otherwise receive the query 230 from the client device 125A. Upon receipt, the query handler 135 can parse the query handler 135 to identify the keywords 235. In some implementations, the query handler 135 can extract the text input included or identified in the query 230. Using the extracted text, the query handler 135 can determine or identify the one or more keywords 235. For example, the query handler 135 can group or identify sets of alphanumeric characters separated from one another by a space or a new line as the keywords 235 of the query 230. In some implementations, the query handler 135 can extract the audio input included or identified in the query 230. The query handler 135 can apply a NLP technique (e.g., speech recognition) to identify keywords 235 from one or more portions of the audio input of the query 230. In applying the NLP technique, the query handler 135 can establish, train, and maintain a speech recognition model to apply to audio to identify keywords 235.

Using the query 230, the query handler 135 can identify or determine the location identifier 225 associated with the client device 125A (or the application 215 running on the client device 125A). The location identifier 225 can reference or identify the location of the client device 125A. The location identifier 225 can correspond to a particular geographic region 130. In some implementations, the query 230 can include or identify the location identifier 225. For example, the location identifier 225 can be included in the metadata of the query 230 in the form of a network address or a geographic address as discussed above. The query handler 135 can extract or identify the location identifier 225 from the query 230 (e.g., from the metadata). In some implementations, the query 230 can exclude or lack the location identifier 225. In some embodiments, the query handler 135 can determine the location identifier 225 by applying positioning techniques, such as geolocation (e.g., global positioning system (GPS)), triangulation, and multilateration (MLAT), among others. In some implementations, the query handler 135 can determine the location identifier 225 by applying an NLP technique (e.g., information extraction or named-entity recognition) to the keywords 235 of the query 230. For instance, the keywords 235 derived from the query 230 can be “Find a pizzeria in London.” From this example, the query handler 135 can apply named-entity recognition to find “London” from the keywords 235 as the location identifier 225 for the client device 125A. In applying the NLP technique, the query handler 135 can train, establish, a maintain a machine learning model (e.g., an artificial neural network or hidden Markov model) or a statistical model for recognizing keywords 235 associated with geographic regions.

In some implementations, the query handler 135 can maintain at least one database 240 for queries and activities from one or more client devices 125. On the database 240, the query handler 135 can maintain at least one log record 245. The log record 245 stored on the database 240 can include a set of recorded queries 230′A-N (hereinafter generally referred to as a recorded query 230′ or recorded inputs). The log record 245 can be, for example, a relational database maintained using a database management system (DBMS). In some implementation, the log record 245 can be maintained for a particular client device 125A, account identifier, or application 215, geographic region 130, among others. Each time a query 230 is received, the query handler 135 can store and maintain at least a portion of the query on the log record 245 as part of the queries 230′. For example, the query handler 135 can store and maintain information derived from the keywords 235 of the query 230 and the location identifier 225, the timestamp, account identifier, the source and destination addresses for webpages of the metadata, among others. In some implementations, the query handler 135 can identify the log record 245 to which the received query 230 is to be stored. For example, the query handler 135 can identify the log record 245 for the particular client device 125A using the client identifier (e.g., an IP address for the client device 125A). Upon identifying, the query handler 135 can store the query 230 into the identified log record 245 as one of the recorded queries 230′.

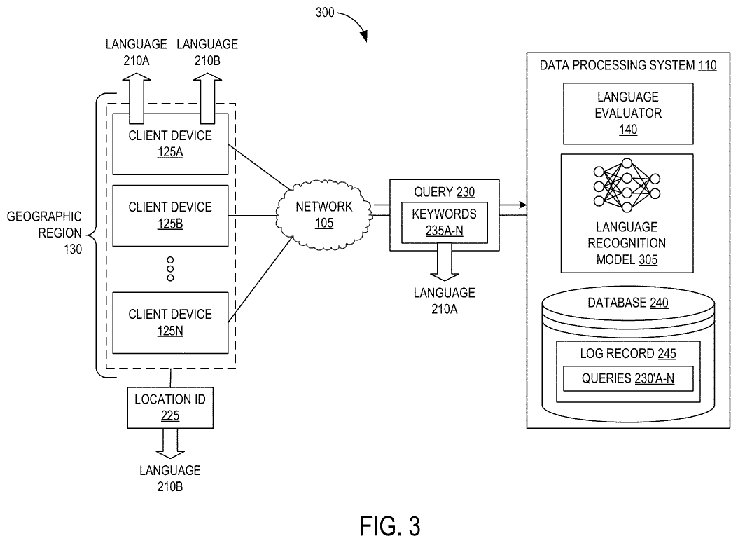

Referring now to FIG. 3, depicted is a block diagram of a location identification phase 300 of the system 100 for selecting content to provide in networked environments. As depicted, the language evaluator 140 can establish and maintain at least one language recognition model 305. The language recognition model 305 can be an artificial intelligence (AI) algorithm or a machine learning (ML) model (e.g., an artificial neural network, an n-gram model, a Bayesian network, a random forest, a support vector machine, or a decision tree, among others). In general, the language recognition model 305 can include a set of inputs, a set of outputs, and a set of weights (sometimes herein referred to as parameters) to relate the inputs and the outputs. The inputs can include text (e.g., the keywords 235 extracted from the query 230). The outputs can include or identify a language 210 in which the text is in. In some implementations, the outputs can include also include a likelihood measure indicating a degree of confidence that the text is for each language 210. The weights can be in accordance with the architecture of the AI algorithm or ML model.

The language recognition model 305 can be trained (e.g., by the language evaluator 140) using a training dataset. The training can be in accordance with a supervised or unsupervised learning algorithm. The training dataset can include corpuses of text for each language 210 labeled for the corpus. By applying the text from each corpus to the language recognition model 305, a result corresponding to one of the languages 210 may be generated from the language recognition model 305. Based on a comparison of the result with the labeled language for the corpus in the training dataset, an error can be determined. The error can be a mean squared error (MSE), root mean square error (RMSE), or cross entropy error, among others. Using the error the weights of the language recognition model 305 can be adjusted or modified. The updating of the weights of the language recognition model 305 can be repeated until convergence. For example, when the change in the values of the weights is determined to be less than a convergence threshold, the weights of the language recognition model 305 can be determined to have converged. The establishment and training of the language recognition model 305 can be performed prior to receipt of the query 230 from one or more of the client devices 125.

The language evaluator 140 executing on the data processing system 110 can identify or determine a language 210 (e.g., as depicted the first language 210A) based on one or more of the keywords 235 of the query 230. The first language 210A can refer to the language used in the keyword 235 of the query 230. To determine, in some implementations, the language evaluator 140 can apply the language recognition model 305 to the keywords 235 of the query 230. In applying, the language evaluator 140 can feed the keywords 235 of the query 230 as the input to the language recognition model 305. The language evaluator 140 can process the input using the weights of the language recognition model 305 to generate or produce an output. The output of the language recognition model 305 can indicate which language 210 the keywords 235 of the query 230 is in. In some implementations, the output can include languages 210 with corresponding likelihood measures. The language evaluator 140 can identify the language 210 from the output generated by the language recognition model 305. In some implementations, the language evaluator 140 can identify the language 210 with the highest likelihood measure as calculated by the language recognition model 305. For example, as depicted, the language evaluator 140 can determine that the keywords 235 of the query 230 received from the client device 125A is in the first language 210A.

The language evaluator 140 can identify or determine a language 210 (e.g., the second language 210B as depicted) associated with the location identifier 225. The second language 210B can refer to the language used in the geographic region 130 associated with the location identifier 225, and can be different from the first language 210A used in the keywords 235 of the query 230. In some implementations, the location identifier 225 can correspond or reference the geographic region 130 (e.g., as depicted). In some implementations, the language evaluator 140 can use a mapping to identify the language 210 associated with the location identifier 225. The mapping may specify or indicate a correspondence between one or more location identifiers 225 and one particular language 210 (or a corresponding language identifier, e.g., in the form of a set of alphanumeric characters). The mapping may be maintained and stored on the database 240. Using the location identifier 225, the language evaluator 140 can search the mapping to find or identify the corresponding language 210.

In some implementations, to identify the language 210 associated with the location identifier 225, the language evaluator 140 can use queries 230′ on the database 240 received from client devices 125 also associated with the same location identifier 225. The language evaluator 140 can access one or more of the log records 245 on the database 240 to identify queries 230′ from client devices 125 associated with the location identifier 225. The queries 230′ identified from the log records 245 can exclude those of the client device 125A from which the query 230 is received. To identify the queries 230′, the language evaluator 140 can use the location identifier 225 to search one or more of the log records 245 maintained on the database 240.

For each identified query 230′ from the log record 245, the language evaluator 140 can apply the language recognition model 305 to identify the language 210 in which the keywords of the query 230′ is in. The application of the language recognition model 305 to the keywords of the query 230′ can be similar to the application of the language recognition model 305 to the keywords 235 of the query 230 as discussed above. In some implementations, the language evaluator 140 can maintain a counter for each language 210 to keep track of the number of queries 230′ determined to be in the respective language 210. The language evaluator 140 can identify the language 210 with the highest counter as associated with the location identifier 225 (and by extension the geographic region 130). For instance, as depicted, the language evaluator 140 can identify the second language 210B as associated with the location identifier 225. In some implementations, the language evaluator 140 can update the mapping using the language 210 identified for the location identifier 225.

With the identifications, the language evaluator 140 can compare the language 210 (e.g., the first language 210A) identified from the keywords 235 of the query 230 and the language 210 (e.g., the second language 210B) associated with the location identifier 225. In some cases, the second language 210B identified for the location identifier 225 can differ from the first language 210A identified from the keywords 235 of the query 230. In other cases, the language 210 identified for the location identifier 225 can be the same or can correspond to the language 210 identified from the keywords 235 of the query 230. When same, the language evaluator 140 can determine that the language 210 identified from the keywords 235 of the query 230 is the same, matches, or corresponds to the language 210 associated with the location identifier 225. Otherwise, when different, the language evaluator 140 can determine that language 210A identified from the keywords 235 of the query 230 differ from, do not match, or do not correspond to the language 210B associated with the location identifier 225. In such scenarios, the language 210B associated with the location identifier 225 (and by extension the geographic region 130) can be sometimes referred herein as a dominant language. Conversely, the language 210A identified from the keywords 235 of the query 230 can be sometimes referred herein as a non-dominant language.

The language evaluator 140 can identify or determine whether client device 125A uses both the language 210 (e.g., the first language 210A) identified from the keywords 235 of the query 230 and the language 210 (e.g., the second language 210B) identified as associated with the location identifier 225. The determination can be in response to the determination that the language 210A identified from the keywords 235 of the query 230 differ from the language 210B associated with the location identifier 225. To determine, the language evaluator 140 can access the database 240 to identify queries 230′ in the log records 245 previously received from the client device 125A. To identify the queries 230′, the language evaluator 140 can use the client identifier or the account identifier to search one or more of the log records 245 maintained on the database 240. For each identified query 230′ from the log record 245, the language evaluator 140 can apply the language recognition model 305 to identify the language 210 in which the keywords of the query 230′ is in. The application of the language recognition model 305 to the keywords of the query 230′ can be similar to the application of the language recognition model 305 to the keywords 235 of the query 230 as discussed above. In some implementations, the language evaluator 140 can calculate, determine, or maintain a counter to keep track of the number of queries 230′ determined to be in the language 210B.

Upon determining the total count of queries 230′ in the language 210B, the language evaluator 140 can compare the count to a threshold number. The threshold number can delineate a value for the counter at which the client device 125A can be determined to use both languages 210A and 210B. When the count does not satisfy (e.g., is less than) the threshold number, the language evaluator 140 can determine that the client device 125A does not use both languages 210A and 210B. The language evaluator 140 can also determine that the client device 125A only or primarily uses the language 210A identified from the keywords 235 of the query 230. The language evaluator 140 can determine that the client device 125A does not use the language 210B identified as associated with the location identifier 225. Conversely, when the count satisfies (e.g., is greater than or equal to) the threshold number, the language evaluator 140 can determine that the client device 125A uses both languages 210A and 210B.

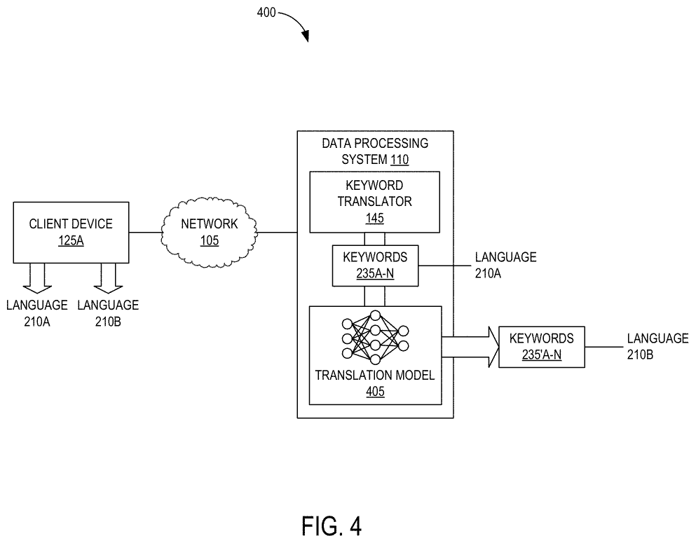

Referring now to FIG. 4, depicted is a block diagram of a keyword translation phase 400 of the system 100 for selecting content to provide in networked environments. As depicted, the keyword translator 145 executing on the data processing system 110 can establish and maintain at least one translation model 405. The translation model 405 can be a neural machine translation (NMT) model, a statistical machine translation (SMT) model, and a rule-based machine translation (RBMT) model, among others. In general, the translation model 405 can include a set of inputs, a set of outputs, and a set of parameters (sometimes herein referred to as weights) to relate the inputs to the outputs. The inputs can include text (e.g., the keywords 235 identified from the query 230) in a language 210 (e.g., the first language 210A). The outputs can include text in another language 210 (e.g., the second language 210B). The language 210 outputted by the translation model 405 can be set or predefined. In some implementations, the translation model 405 can be particular to a pair of languages (e.g., translating from the first language 210A to the second language 210B). In some implementations, the translation model 405 can be general and can be used to translate between any pair of languages. The parameters can be in accordance with the architecture or algorithm used for the translation model 405.

The translation model 405 can be trained (e.g., by the keyword translator 145) using a training dataset. The training can be in accordance with a supervised or unsupervised learning algorithm. The training dataset can include corpuses of text in various languages 210. In some implementations, the training dataset can include corpuses of text acquired from search engine queries. Pairs of textual corpuses can be labeled as translations of one another. For example, in a pair, one corpus can include original text in the first language 210A and the other corpus can include text in the second language 210B translated from the first language 210A. To train the translation model 405, the keyword translator 145 can identify a pair of corpuses from the training dataset. With the identification, the keyword translator 145 can apply the translation model 405 to a text from the pair in one language 210. By applying, the keyword translator 145 can generate text in the target language 210. The keyword translator 145 can compare the text in the target language 210 from the pair of corpuses with the resultant text also in the target language 210 generated from the translation model 405. Based on the comparison, the keyword translator 145 can calculate or determine an error. The error can be a mean squared error (MSE), root mean square error (RMSE), or cross entropy error, among others. Using the error the parameters of the translation model 405 can be adjusted or modified. The updating of the parameters of the translation model 405 can be repeated until convergence. For example, when the change in the values of the weights is determined to be less than a convergence threshold, the parameters of the translation model 405 can be determined to have converged. The establishment and training of the translation model 405 can be performed prior to receipt of the query 230 from one or more of the client devices 125.

Using the translation model 405, the keyword translator 145 can determine or generate one or more keywords 235′A-N (hereinafter generally referred to as translated keywords 235′) based on the keywords 235 parsed from the query 230. The generation of the keywords 235′ can be performed when the client device 125A is determined to use the first language 210A and the second language 210B. In contrast, the generation of the keywords 235′ can be omitted or prevented when the client device 125A is determined to not use the second language 210B. To generate, the keyword translator 145 can apply the translation model 405 to the keywords 235 in the first language 210A (e.g., as depicted). In some implementations, in applying, the keyword translator 145 can set or configure the target language of the translation model 405 to the second language 210B (e.g., as depicted). The keyword translator 145 can feed the keywords 235 of the query 230 in the first language 210A into the translation model 405. The keyword translator 145 can process the input using the parameters of the translation model 405 to generate or produce an output. The output of the translation model 405 can include keywords 235′ in the second language 210B. The keyword translator 145 can identify the keywords 235′ in the second language 210B generated from the translation model 405.

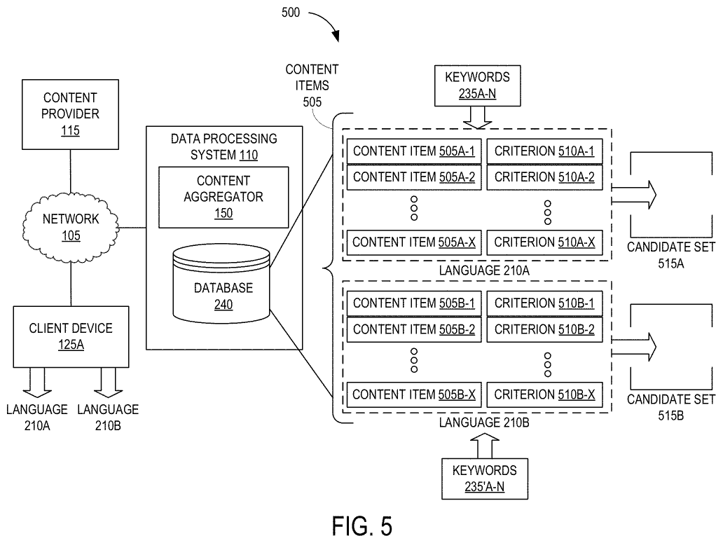

Referring now to FIG. 5, depicted is a block diagram of a content item aggregation phase 500 of the system 100 for selecting content to provide in networked environments. As depicted, the content aggregator 150 executing on the data processing system 110 can maintain a set of content items 505 from one or more content providers 115 on the database 240 (or a separate database). Each content item 505 can correspond to or include a text, an image, audio, video, or multimedia content to be presented via the client device 125. The content item 505 can correspond to or include an object to be inserted on an information resource (e.g., the information resource 220). The object can be, for example, an inline frame, a text object, an image, an audio object, a canvas object, or a video object, among others, in accordance with HTML5. Each content item 505 can be referenced by an identifier, such as a URL or another set of alphanumeric characters, among others.

In some implementations, the content aggregator 150 can retrieve, identify, or receive the content items 505 themselves from the content providers 115 via the network 105. Upon receipt, the content aggregator 150 can store and maintain the content items 505 on the database 240. In some implementations, the content aggregator 150 can retrieve, identify, or receive identifiers for the content items 505 from the content providers 115. An identifier for the content item 505 can reference or correspond to a location of content item 505 stored or maintained by the content provider 115, and can be for example, a URL or another set of alphanumeric characters, among others. Upon receipt, the content aggregator 150 can store and maintain the identifiers for the content items 505 on the database 240.

The content items 505 can include content in one or more languages 210 (e.g., the first language 210A and the second language 210B as depicted). For example, as depicted, the content items 505 can include content items 505A-1 to 505A-X in the first language 210A (hereinafter generally referred to as content items 505A). The content items 505 can also include content items 505B-1 to 505B-X in the second language 210B (hereinafter generally referred to as content items 505B). In some implementations, the identification of the content item 505 as in one language can be provided by the content provider 115. For instance, when submitting the content item 505 to the data processing system 110, the content provider 115 can send an indication labeling the language 210 of the content item 505 (e.g., as one of the first language 210A or the second language 210B). In some implementations, the identification of content items 505 as in one language 210 can be performed by the language evaluator 140 in the manner described above. For example, upon receipt of the content item 505, the language evaluator 140 can apply the language recognition model 305 to the content of the content item 505 to determine the language 210.

Each content item 505 can be associated with at least one selection criterion 510A-1 to 510B-X (hereinafter generally referred to as selection criterion 510). The selection criterion 510 can specify, define, or identify parameters in accordance to which the associated content item 505 is to be selected for provision to the client device 125. For instance, the content item 505 can include text and images for a tennis racquet by company “ABC”, and the associated selection criterion 510 can specify target keywords, such “ABC” and “tennis.” Receipt of a query containing the words “ABC” or “tennis” from one client device 125 can make the content item 505 to be selected for a candidate for provision to the client device 125. The parameters of the selection criterion 510 can include target keywords, account segment, geographic region, and device type, among others. The selection criterion 510 can be configured or set by the content provider 115 that provided the content item 505 to the data processing system 110.

Using keywords 235 in the first language 210A, the content aggregator 150 can retrieve, select, or otherwise identify a subset of content items 505A in the first language 210A to include in at least one candidate set 515A. The identification of the subset of content items 505A in the first language 210A can be performed when the keywords 235 of the query 230 are in the first language 210A or when the client device 125A is determined to use at least the first language 210A. The candidate set 515A can include the subset of content items 505A in the first language 210A with selection criteria 510A matching or corresponding to the keywords 235 of the query 230. In other words, content items 505 in the same language 210A as the keywords 235 of the query 230 can be identified for contention to be selected to be provided to the client device 125A. Moreover, when the client device 125A is determined to only use the first language 210A and not the second language 210B, the content aggregator 150 can identify content items 505A in the first language 210A without identifying any content items 505B in the second language 210B (or vice-versa in terms language). As such, the content items 505 from which to select to provide can be limited to the first language 210A and to the exclusion of the second language 210B.

In identifying, the content aggregator 150 can compare the keywords 235 of the query 230 with the selection criterion 510A of each content item 505A. For example, the content aggregator 150 can compare the keywords 235 of the query 230 to the target keywords defined by the content provider 115 in the selection criterion 510A. When the selection criterion 510A of the content item 505A is determined to match or correspond to keyword 235, the content aggregator 150 can include the content item 505A into the candidate set 515A. Otherwise, when the selection criterion 510A of the content item 505A is determined to not match or correspond to keywords 235, the content aggregator 150 can exclude the content item 505A from the candidate set 515A. The content aggregator 150 can repeat the comparison of the selection criteria 510A with the keywords 235 through the set of content items 505A in the first language 210A.

Furthermore, the content aggregator 150 can retrieve, select, or otherwise identify a subset of content items 505B in the second language 210B using the keywords 235′ generated from the keywords 235 of the query 230 to include in at least one candidate set 515B. The identification of the subset of content items 505B in the second language 210B can be performed when the client device 125A is determined to use the first language 210A and the second language 210B. The candidate set 515B can include the subset of content items 505B in the second language 210B with selection criteria 510B matching or corresponding to the keywords 235′ generated from the keyword 235. In this manner, the set of content items 505 from which to select to provide to the client device 125A can be expanded to include not only the content items 505A in the first language 210A in which the query 230 is in, but also the content items 505B in the second language 210B determined to be also used by the client device 125A.

To identify, the content aggregator 150 can compare the keywords 235′ with the selection criterion 510B of each content item 505B. For example, the content aggregator 150 can compare the keywords 235′ translated from the keyword 235 to the target keywords defined by the content provider 115 in the selection criterion 510B. When the selection criterion 510 of the content item 505B is determined to match or correspond to keyword 235′, the content aggregator 150 can include the content item 505B into the candidate set 515B. Otherwise, when the selection criterion 510 of the content item 505B is determined to not match or correspond to keywords 235′, the content aggregator 150 can exclude the content item 505B from the candidate set 515B. The content aggregator 150 can repeat the comparison of the selection criteria 510B with the keywords 235 through the set of content items 505B in the second language 210B.

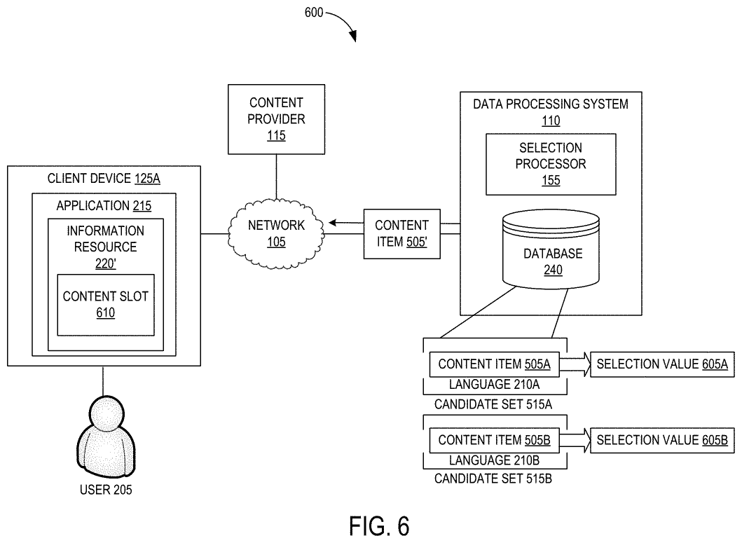

Referring now to FIG. 6, depicted is a block diagram of a content selection phase 600 of the system 100 for selecting content to provide in networked environments. As depicted, the selection processor 155 executing on the data processing system 110 can calculate, determine, or otherwise generate selection values 605A or 605B (hereinafter generally referred to as selection values 605) for the selected content items 505. For example, the selection processor 155 can generate the selection value 605A for the content item 505A of the candidate set 515A in the first language 210A. Furthermore, if there are any selected for the candidate set 515B, the selection processor 155 can generate the selection value 605B for the content item 505B of the candidate set 515B in the second language 210B. The selection values 605 can be used to select to at least one content item 505′ from the candidate sets 515A and 515B to provide to the client device 125A for presentation

The selection processor 155 can use any number of factors to generate the selection value 605 for each content item 505. In some implementations, the selection processor 155 can determine or generate a predicted interaction rate (sometimes referred herein as an expected interaction rate) for each content item 505. The predicted interaction can be measured in terms of a likelihood of viewing the content item 505, performing a particular interaction (e.g., click, screen touch, or hover over) with the content item 505, or performing an interaction with an information resource (e.g., the landing page) linked to the content item 505. In some implementations, the selection processor 155 can access the database 240 to identify logged interactions by various client devices 125 with the content item 505. The logged interactions can be maintained on the database 240 using the log record 245 for the client devices 125. The selection processor 155 can identify a subset of interactions for client devices 125 having similar characteristic as the client device 125A, such as the geographic region 130, a user segment trait of the user 205, and device type, among others. Using the subset, the selection processor 155 can determine the predicted interaction rate for the client device 125A with the content item 505. The selection processor 155 can use the predicted interaction rate as the selection value 605.

In generating the prediction interaction rate for the content item 505, the selection processor 155 can calculate, determine, or identify interaction rates by the client device 125A with content items 505 in various languages 210. The interaction can be in terms of a likelihood of viewing the content item 505, performing a particular interaction (e.g., click, screen touch, or hover over) with the content item 505, or performing an interaction with an information resource (e.g., the landing page) linked to the content item 505. For example, the selection processor 155 can determine an interaction rate by the client device 125A with content items 505A in the first language 210A and a separate interaction rate by the client device 125A with content items 505B in the second language 210B. The selection processor 155 can access the database 240 to identify logged interactions by the client device 125A. The logged interactions can be maintained on the database 240 using the log record 245 for the particular client device 125A.

Upon identification of the logged interactions, the selection processor 155 can perform the determinations of the interaction rates. For example, the selection processor 155 can use the corresponding logged interactions to determine the interaction rate by the client device 125A with content items 505A in the first language 210A. Furthermore, the selection processor 155 can use the corresponding logged interactions to determine the interaction rate by the client device 125A with content items 505B in the first language 210B. In some implementations, the selection processor 155 can use the interaction rates as the selection values 605 for the content items 505. In some implementations, the selection processor 155 can use the interaction rates to adjust or modify the selection values 605 for the content items 505. For example, the selection processor 155 can modify the selection value 605A for the content item 505A in the first language 210A using the interaction rate determined for the client device 125A with content items 505 in the same first language 210A. Conversely, the selection processor 155 can modify the selection value 605B for the content item 505B in the second language 210B using the interaction rate determined for the client device 125A with content items 505 in the same second language 210B.

In some implementations, the selection processor 155 can determine or generate the selection value 605 based on a comparison of the language 210A used in the keywords 235 of the query 230 versus the language 210 used in the content item 505. As discussed, the content items 505 in the candidate set 515A can be in the first language 210A and the content items 505 in the candidate set 515B can be in the second language 210B. When the language 210A used in the keywords 235 of the query 230 differ from the language 210B used in the content item 505B, the selection processor 155 can adjust or modify (e.g., by decreasing) the selection value 605B for the content item 505B in the second language 210B. On the other hand, when the language 210B used in the keywords 235 of the query 230 is the same as the language 210A used in the content item 505A, the selection processor 155 can adjust or modify (e.g., by increasing) the selection value 605A for the content item 505A in the first language 210A.

Based on the determinations of the selection values 605, the selection processor 155 can select at least one content item 505′ from the content items 505 of the candidate set 515A or the candidate set 515B (if any). In some implementations, the selection processor 155 can select the content item 505′ corresponding to the highest selection value 605. In some implementations, the selection processor 155 can select the content item 505′ in accordance with a content selection protocol. The content selection protocol can include, for example, a real-time bidding protocol and a header bidding protocol, among others. The operations of the content selection protocol can be distributed among the data processing system 110, the content provider 115, and the client device 125. In performing the content selection protocol, the selection processor 155 can retrieve, identify, or receive a submission value (e.g., a bid value) from each content provider 115 with a content item 505 in the candidate set 515A or 515B. In some implementations, the selection processor 155 can combine the submission value with the selection value 605 of the content item 505 of the content provider 115 to modify or determine the selection value 605. Upon combination, the selection processor 155 can identify or select the content item 505 corresponding to the highest selection value 605 to use as the selected content item 505′. The selected content item 505′ can be from the candidate set 515A in the first language 210A or the candidate set 515B in the second language 210B.

Upon selection, the selection processor 155 can provide, send, or transmit the content item 505′ to the client device 125A. In some implementations, the selection processor 155 can provide, send, or transmit the identifier (e.g., the URL) for the content item 505′ to the client device 125A. The application 215 running on the client device 125A can receive the content item 505′ sent from the data processing system 110 via the network 105. In some implementations, the application 215 can retrieve the content item 505′ referenced by the identifier from the content provider 115 or the network 105. Upon receipt, the application 215 can present the content item 505′. In some implementations, the application 215 running on the client device 125A can insert the content item 505′ into the content slot 610 of the information resource 220′. The information resource 220′ can be the same as the information resource 220 discussed above or can be a subsequently loaded and presented by the application 215 on the client device 125A.

In this manner, the system 100 can improve the overall functionalities of the data processing system 110 and the client device 125. By determining that the user 205 of the client device 125A is capable of understanding multiple languages 210A and 210B in an objective fashion, the candidate sets 515A and 515B can be expanded to include content items in these languages 210A and 210B. In the end, the content item 505′ selected from the candidate sets 515A and 515B can be in either language 210A or 210B, and can be provided for presentation to the user 205 operating the client device 125A. As a result, the information resource 220′ can be in the first language 210A, while the content item 505′ inserted into the content slot 610 can be in the second language 210B. The inclusion of content in multiple languages 210A and 210B can reduce the consumption of computing resources at both the client device 125 and the data processing system 110, by eliminating the requisite of providing separate queries 230 for content in those languages 210. Furthermore, the human-computer interaction (HCl) between the user 205 and the system 100 may be enhanced with the presentation of content in potentially multiple languages 210.

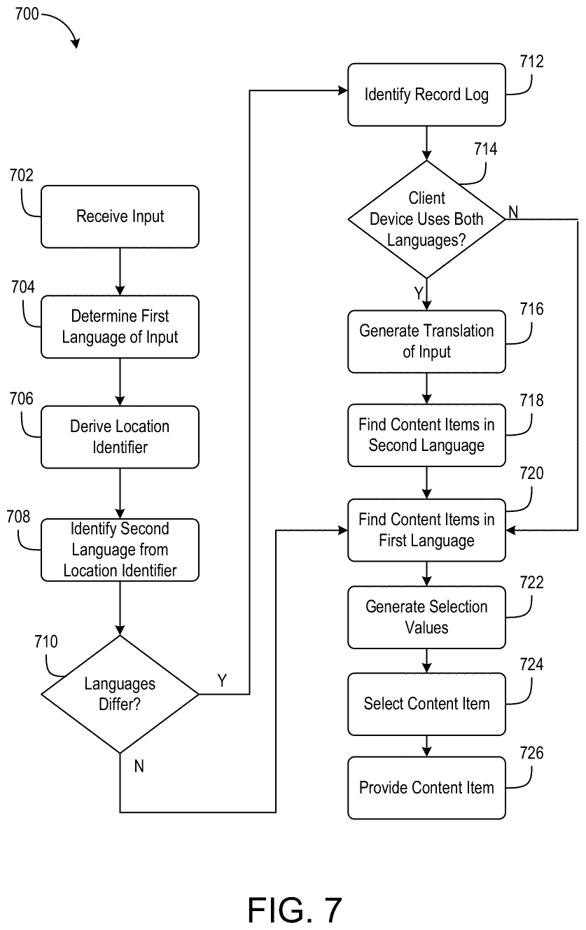

Referring now to FIG. 7, depicted is a flow diagram depicting on implementation of a method 700 of selecting content to provide in networked environments. The functionality described herein with respect to method 700 can be performed or otherwise executed by the system 100 as shown on FIGS. 1-6 or a computing system 800 as shown in FIG. 8. In brief overview, a data processing system can receive an input (702). The data processing system can determine a first language of the input (704). The data processing system can derive a location identifier (706). The data processing system can identify a second language from the location identifier (708). The data processing system can determine whether the first language and the second language differs (710). If the languages differ, the data processing system can identify a record log (712). The data processing system can determine whether the client devices uses both the first language and the second language (714). If both languages are used, the data processing system can generate a translation of the input (716). The data processing system can find a set of content items in the second language (718). Otherwise, the data processing system can find a set of content items in the first language (720). The data processing system can generate selection values (722). The data processing system can select a content item (724). The data processing system can provide the content item (726).

In further detail, a data processing system (e.g., the data processing system 110) can receive an input (e.g., the query 230) (702). The data processing system can receive the input from a client device (e.g., the client device 125A). The input may correspond to textual input entered via an user interface element, an image input enter via a camera or an image file upload, or an audio input acquired via a microphone on the client device, among others. The input can include one or more keywords (e.g., the keywords 235) and metadata. The keywords can be in a particular language (e.g., the language 210). The metadata can include or can be used to identify a location identifier of the client device.

The data processing system can determine a first language (e.g., the first language 210A) of the input (704). Upon receipt of the input, the data processing system may parse the input to identify the keywords of the input. The data processing system can identify the language from the keywords of the input. To identify the language, the data processing system can apply a language recognition model (e.g., the language recognition model 305).

The data processing system can derive a location identifier (e.g., the location identifier 225) (706). The location identifier can reference or identify the location in which the client device is located. The data processing system can parse the input to identify metadata. Using the metadata or the keywords of the input, the data processing system can determine or identify the location identifier. In some implementations, the data processing system can apply positioning techniques (e.g., geolocation, triangulation, and multilateration) to determine the location identifier for the client device.

The data processing system can identify a second language (e.g., the second language 210B) from the location identifier (e.g., the location identifier 225) (708). The data processing system can use a mapping of location identifier with various languages. The data processing system can search the mapping using the location identifier to find the language associated with a geographic region (e.g., the geographic region 130). The mapping can be maintained and developed by the data processing system using previous queries.

The data processing system can determine whether the first language and the second language differ (710). When the languages differ, the data processing system can determine that the first language and the second language differ. Conversely, when the languages are the same, the data processing system can determine that the first language and the second language do not differ.

If the languages differ, the data processing system can identify a record log (e.g., the log record 245) (712). The data processing system can access the log record maintained on a database (e.g., the database 240). The log record can include inputs (e.g., the queries 230′) previously received from the client device. The data processing system can identify the language used in the previously received inputs. The language can be same as the current input or different.

The data processing system can determine whether the client devices uses both the first language and the second language (714). Based on the identification of the languages from the inputs of the log record, the data processing system can perform the determination. When at least some of the inputs of the log record are determined to the second language, the data processing system can determine that the client device uses both the first and second languages. Conversely, when none of the inputs of the log record are determined in the second language, the data processing system can determine that the client device only uses the first language and not the second language.

If both languages are used, the data processing system can generate a translation of the input (e.g., the query 230′) (716). The data processing system can apply a translation model (e.g., the translation model 405) to the keywords of the input to generate keywords (e.g., the keywords 235′) for the translation. The data processing system can set the translation model to output keywords in the second language.

The data processing system can find a set of content items in the second language (e.g., the content item 505B in the candidate set 515B) (718). Each content item in the second language can be associated with a target keyword (e.g., as part of the selection criterion 510). The data processing system can find content items in the second language with target keywords matching the translated keywords. Upon identification, the data processing system can include the content item into the candidate set.

Otherwise, the data processing system can find a set of content items in the first language (e.g., the content item 505A in the candidate set 515A) (720). Each content item in the first language can also be associated with a target keyword (e.g., as part of the selection criterion 510). The data processing system can find content items in the first language with target keywords matching the original keywords of the input. Once found, the data processing system can include the content item into the candidate set.

The data processing system can generate selection values (e.g., selection values 605) (722). The data processing system can generate a selection value for each content item in the candidate sets using any number of factors. The data processing system can determine an expected prediction interaction rate for each content item using previously recorded interactions with the content item. Upon determination, the data processing system can use the expected predicted interaction rate as the selection value for the content item.

The data processing system can select a content item (e.g., the content item 505′) (724). The data processing system can use a content selection protocol to select the content item. Under the content selection protocol, the data processing system can fetch submission values from content providers (e.g., the content provider 115) for the content items. Using both the submission values and the selection values, the data processing system can identify the select the content item corresponding to the highest value.

The data processing system can provide the content item (726). The data processing system can send the content item to the client device. Upon receipt, the client device can present the content item. The client device can insert the content item into a content slot (e.g., the content slot 620) of an information resource (e.g., the information resource 220′) for display.

FIG. 8 shows the general architecture of an illustrative computer system 800 that may be employed to implement any of the computer systems discussed herein (including the data processing system 110 and its components, the content provider 115, the content publisher 120, and the client device 125) in accordance with some implementations. The computer system 800 can be used to provide information via the network 830 for display. The computer system 800 comprises one or more processors 820 communicatively coupled to memory 825, one or more communications interfaces 805 communicatively coupled with at least one network 830 (e.g., the network 105), and one or more output devices 810 (e.g., one or more display units) and one or more input devices 815.

The processor 820 can include a microprocessor, application-specific integrated circuit (ASIC), field-programmable gate array (FPGA), etc., or combinations thereof. The memory may include, but is not limited to, electronic, optical, magnetic, or any other storage or transmission device capable of providing the processor with program instructions. The memory 825 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). The memory 825 can include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language.

The processor(s) 820 shown in FIG. 8 may be used to execute instructions stored in the memory 825 and, in so doing, also may read from or write to the memory various information processed and or generated pursuant to execution of the instructions. The processors 820 coupled with memory 825 (collectively referred herein as a processing unit) can be included in the components of the system 100, such as the data processing system 110 (and also the content provider 115, the content publisher 120, and the client device 125). For example, the data processing system 110 can include the memory 825 as the database 240. The processors 820 coupled with memory 825 (collectively referred herein as a processing unit) can be included in the content provider 115. For example, the content provider 115 can include the memory 825 to store the content items 505 or 505′. The processors 820 coupled with memory 825 (collectively referred herein as a processing unit) can be included in the content publisher 120. For example, the content publisher 120 can include the memory 825 to store the information resource 220. The processors 820 coupled with memory 825 (collectively referred herein as a processing unit) can be included in the client device 125.

The processor 820 of the computer system 800 also may be communicatively coupled to or made to control the communications interface(s) 805 to transmit or receive various information pursuant to execution of instructions. For example, the communications interface(s) 805 may be coupled to a wired or wireless network, bus, or other communication means and may therefore allow the computer system 800 to transmit information to or receive information from other devices (e.g., other computer systems). While not shown explicitly in the system of FIGS. 1-6, one or more communications interfaces facilitate information flow between the components of the system 800. In some implementations, the communications interface(s) may be configured (e.g., via various hardware components or software components) to provide a website as an access portal to at least some aspects of the computer system 800. Examples of communications interfaces 805 include user interfaces (e.g., the application 215, the information resource 220 or 220′, and content item 505 or 505′), through which the user can communicate with other devices of the system 100.

The output devices 810 of the computer system 800 shown in FIG. 8 may be provided, for example, to allow various information to be viewed or otherwise perceived in connection with execution of the instructions. The input device(s) 815 may be provided, for example, to allow a user to make manual adjustments, make selections, enter data, or interact in any of a variety of manners with the processor during execution of the instructions. Additional information relating to a general computer system architecture that may be employed for various systems discussed herein is provided further herein.

The network 830 can include computer networks such as the internet, local, wide, metro or other area networks, intranets, satellite networks, other computer networks such as voice or data mobile phone communication networks, and combinations thereof. The network 830 may be any form of computer network that relays information among the components of the system 100, such as the data processing system 110 and its components, the content provider 115, the content publisher 120, and the client device 125. For example, the network 830 may include the Internet and/or other types of data networks, such as a local area network (LAN), a wide area network (WAN), a cellular network, satellite network, or other types of data networks. The network 830 may also include any number of computing devices (e.g., computer, servers, routers, network switches, etc.) that are configured to receive and/or transmit data within network 830. The network 830 may further include any number of hardwired and/or wireless connections. The client device 125 may communicate wirelessly (e.g., via WiFi, cellular, radio, etc.) with a transceiver that is hardwired (e.g., via a fiber optic cable, a CAT5 cable, etc.) to other computing devices in network 830.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable a receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, or other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In some implementations, the features may be implemented on a laptop computer or other personal computer, a smartphone, other mobile phone, handheld computer, a tablet PC, or other computing device. In some implementations, the features disclosed herein may be implemented on a wearable device or component (e.g., smart watch) which may include a processing module configured to integrate internet connectivity (e.g., with another computing device or the network 830).

The operations described in this specification can be implemented as operations performed by a data processing apparatus on data stored on one or more computer-readable storage devices or on data received from other sources. The terms “data processing apparatus”, “data processing system”, “user device” or “computing device” encompasses all kinds of apparatuses, devices, and machines for processing data, including by way of example a programmable processor, a computer, a system on a chip or multiple chips, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from read-only memory or random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well. For example, feedback provided to the user can include any form of sensory feedback, e.g., visual feedback, auditory feedback, or tactile feedback, and input from the user can be received in any form, including acoustic, speech, or tactile input. In addition, a computer can interact with a user by sending documents to and receiving documents from a device that is used by the user, for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 800 or system 100 can include clients and servers. For example, the data processing system 110 and its components, the content provider 115, the content publisher 120, and the client device 125 of the system 100 can each include one or more servers in one or more data centers or server farms. A client (e.g., the client device 125) and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the query handler 135, the language evaluator 140, the keyword translator 145, the content aggregator 150, and the selection processor 155 can be part of the data processing system 110, a single module, a logic device having one or more processing modules, or one or more servers.

For situations in which the systems discussed herein collect personal information about users, or may make use of personal information, the users may be provided with an opportunity to control whether programs or features that may collect personal information (e.g., information about a user's social network, social actions or activities, a user's preferences, or a user's location), or to control whether or how to receive content from a content server or other data processing system that may be more relevant to the user. In addition, certain data may be anonymized in one or more ways before it is stored or used, so that personally identifiable information is removed when generating parameters. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by the content server.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided herein relate to selecting content to provide in networked environments, the systems and methods described herein can include applied to other environments. The foregoing implementations are illustrative rather than limiting of the described systems and methods. The scope of the systems and methods described herein is thus indicated by the appended claims, rather than the foregoing description, and changes that come within the meaning and range of equivalency of the claims are embraced therein.

The disclosure comprises the following clauses:

1. A method of selecting content to provide in networked environments, comprising:
receiving, by a data processing system having one or more processors, an input from a client device, the input including one or more keywords in a first language;
determining, by the data processing system, the first language based on the one or more keywords of the input;
determining, by the data processing system using the input, a location identifier identifying a location of the client device;
identifying, by the data processing system, a second language associated with the location identifier, the second language different from the first language;
identifying, by the data processing system, a first plurality of content items in the first language and a second plurality of content items in the second language using the one or more keywords of the input; and
providing, by the data processing system to the client device, a content item from one of the first plurality of content items and the second plurality of content items.

2. The method of clause 1, further comprising:
identifying, by the data processing system, a second input from the client device, the second input including one or more second keywords in accordance with the second language; and
determining, by the data processing system based on the one or more keywords of the input and the one or more second keywords of the second input, that the client device uses the first language and the second language, and
wherein identifying the second plurality of content items further comprises identifying the second plurality of content items responsive to determining that the client device uses the first language and the second language.

3. The method of any preceding clause, further comprising generating, by the data processing system responsive to determining that the client device uses the first language and the second language, one or more second keywords in the second language based on the one or more keywords in the first language, and
wherein identifying the first plurality of content items further comprises identifying the first plurality of content items using the one or more keywords in the first language, and
wherein identifying the second plurality of content items further comprises identifying the second plurality of content items using the one or more second keywords in the second language.

4. The method of any preceding clause, further comprising:
identifying, by the data processing system, a plurality of inputs from a plurality of client devices, each of the plurality of inputs having one or more second keywords in the second language, each of the plurality of client devices associated with the location identifier corresponding to the location identifier for the client device; and
wherein identifying the second language as associated with the location identifier further comprises determining the second language based on the one or more second keywords from each of the plurality of inputs.

5. The method of any preceding clause, further comprising:
determining, by the data processing system, that the first language determined from the one or more keywords of the input differs from the second language associated with the location identifier of the input; and
wherein identifying the first plurality of the content items and the second plurality of content items further comprises identifying the first plurality of the content items and the second plurality of content items responsive to determining that the first language differs from the second language.

6. The method of any preceding clause, further comprising:
generating, by the data processing system, a selection value for each content item of the plurality of first content items and the second plurality of content items based on comparison of a language of the content item and the first language determined from the query; and
selecting, by the data processing system, the content item from the first plurality of content items and the second plurality of content items based on a corresponding plurality of selection values in accordance with a content selection protocol.

7. The method of any preceding clause, further comprising:
determining, by the data processing system using a log record for the client device, a first interaction rate with content items in the first language and a second interaction rate with content items in the second language;
generating, by the data processing system, a selection value for each content item of the plurality of first content items and the second plurality of content items based on at least one of the first interaction rate and the second interaction rate; and
selecting, by the data processing system, the content item from the first plurality of content items and the second plurality of content items based on a corresponding plurality of selection values in accordance with a content selection protocol.

8. The method of any preceding clause, wherein receiving the input further comprises receiving a query via a search engine accessed via an application executing on the client device, the query including one or more keywords; and
wherein providing the content item further comprises providing the content item for presentation via the application executing on the client device subsequent to receipt of the query.

9. The method of any preceding clause, further comprising:
receiving, by the data processing system, a second input from a second client device, the second input identifying one or more second keywords in the first language, the second client device associated with the location identifier;
determining, by the data processing system, that the second client device uses the first language and does not use the second language identified as associated with the location identifier based on a plurality of inputs from the second client device; and
identifying, by the data processing system, a third plurality of content items in the first language without any content items in the second language.

10. The method of any preceding clause, further comprising:
receiving, by the data processing system prior to the input, a second input from the client device, the second input including one or more second keywords in the second language;
determining, by the data processing system, that the second language based on the one or more second keywords; and
providing, by the data processing system responsive to determining that the second language, a third plurality of content items in the second language without identifying any content items in the first language.

11. A system for selecting content to provide in networked environments, comprising:
a data processing system having one or more processors coupled with memory, configured to:
   receive an input from a client device, the input including one or more keywords in a first language;
   determine the first language based on the one or more keywords of the input;
   determine, using the input, a location identifier identifying a location of the client device;
   identify a second language associated with the location identifier, the second language different from the first language;
   identify a first plurality of content items in the first language and a second plurality of content items in the second language using the one or more keywords of the input; and
   provide, to the client device, a content item from one of the first plurality of content items and the second plurality of content items.

12. The system of clause 11, wherein the data processing system is further configured to:
identify a second input from the client device, the second input including one or more second keywords in accordance with the second language;
determine, based on the one or more keywords of the input and the one or more second keywords of the second input, that the client device uses the first language and the second language; and
identify the second plurality of content items responsive to determining that the client device uses the first language and the second language.

13. The system of any of clauses 11-12, wherein the data processing system is further configured to:
generate, responsive to determining that the client device uses the first language and the second language, one or more second keywords in the second language based on the one or more keywords in the first language;
identify the first plurality of content items using the one or more keywords in the first language, and
identify the second plurality of content items using the one or more second keywords in the second language.

14. The system of any of clauses 11-13, wherein the data processing system is further configured to:
identify a plurality of inputs from a plurality of client devices, each of the plurality of inputs having one or more second keywords in the second language, each of the plurality of client devices associated with the location identifier corresponding to the location identifier for the client device; and
determine the second language based on the one or more second keywords from each of the plurality of inputs.

15. The system of any of clauses 11-14, wherein the data processing system is further configured to:
determine that the first language determined from the one or more keywords of the input differs from the second language associated with the location identifier of the input; and
identify the first plurality of the content items and the second plurality of content items responsive to determining that the first language differs from the second language.

16. The system of any of clauses 11-15, wherein the data processing system is further configured to:
generate a selection value for each content item of the plurality of first content items and the second plurality of content items based on comparison of a language of the content item and the first language determined from the query; and
select the content item from the first plurality of content items and the second plurality of content items based on a corresponding plurality of selection values in accordance with a content selection protocol.

17. The system of any of clauses 11-16, wherein the data processing system is further configured to:
determine, using a log record for the client device, a first interaction rate with content items in the first language and a second interaction rate with content items in the second language;
generate a selection value for each content item of the plurality of first content items and the second plurality of content items based on at least one of the first interaction rate and the second interaction rate; and
select the content item from the first plurality of content items and the second plurality of content items based on a corresponding plurality of selection values in accordance with a content selection protocol.

18. The system of any of clauses 11-17, wherein the data processing system is further configured to:
receive a query via a search engine accessed via an application executing on the client device, the query including one or more keywords; and
provide the content item for presentation via the application executing on the client device subsequent to receipt of the query.

19. The system of any of clauses 11-18, wherein the data processing system is further configured to:
receive a second input from a second client device, the second input identifying one or more second keywords in the first language, the second client device associated with the location identifier;
determine that the second client device uses the first language and does not use the second language identified as associated with the location identifier based on a plurality of inputs from the second client device; and
identify a third plurality of content items in the first language without any content items in the second language.

20. The system of any of clauses 11-19, wherein the data processing system is further configured to:
receive, prior to the input, a second input from the client device, the second input including one or more second keywords in the second language;
determine that the second language based on the one or more second keywords; and
provide, responsive to determining that the second language, a third plurality of content items in the second language without identifying any content items in the first language.

1. A method of selecting content to provide in networked environments, comprising:
receiving, by a data processing system having one or more processors, from a client device, a request for content to insert into a content slot of an information resource, the request including one or more keywords in a first language;
determining, by the data processing system, the first language based on the one or more keywords of the request and requests received prior to the request;
determining, by the data processing system, using the request, a location identifier identifying a location of the client device;
identifying, by the data processing system, a second language associated with the location identifier, the second language different from the first language;
determining, by the data processing system, that the client device uses both the first language and the second language;
identifying, by the data processing system, a first plurality of content items in the first language and a second plurality of content items in the second language based on the one or more keywords of the request in the first language, responsive to determining that both the first language and the second language are used on the client device;
selecting, by the data processing system, a content item from one of the first plurality of content items and the second plurality of content items in accordance with a content selection protocol; and
providing, by the data processing system, the content item to the client device to insert into the content slot of the information resource.

2. The method of claim 1, further comprising:
identifying, by the data processing system, a second request from the client device, the second request including one or more second keywords in accordance with the second language; and
determining, by the data processing system based on the one or more keywords of the request and the one or more second keywords of the second request, that the client device uses the first language and the second language.

3. The method of claim 1, further comprising generating, by the data processing system, responsive to determining that the client device uses the first language and the second
language, one or more second keywords in the second language based on the one or more keywords in the first language, and
wherein identifying the first plurality of content items further comprises identifying the first plurality of content items using the one or more keywords in the first language, and wherein identifying the second plurality of content items further comprises identifying the second plurality of content items using the one or more second keywords in the second language.

4. The method of claim 1, further comprising:
identifying, by the data processing system, from a log record, a plurality of inputs from a plurality of client devices, each of the plurality of inputs having one or more second keywords in the second language, each of the plurality of client devices associated with the location identifier matching the location identifier for the client device; and
wherein identifying the second language as associated with the location identifier further comprises determining the second language based on the one or more second keywords from each of the plurality of inputs.

5. The method of claim 1, further comprising:
determining, by the data processing system, that the first language determined from the one or more keywords of the request differs from the second language associated with the location identifier of the request; and
wherein identifying the first plurality of the content items and the second plurality of content items further comprises identifying the first plurality of the content items and the second plurality of content items responsive to determining that the first language differs from the second language.

6. The method of claim 1, further comprising:
generating, by the data processing system, a selection value for each content item of the plurality of first content items and the second plurality of content items based on comparison of a language of the content item and the first language determined from the request; and
selecting, by the data processing system, the content item from the first plurality of content items and the second plurality of content items based on a corresponding plurality of selection values in accordance with the content selection protocol.

7. The method of claim 1, further comprising:
determining, by the data processing system, using a log record for the client device, a first interaction rate with content items in the first language and a second interaction rate with content items in the second language;
generating, by the data processing system, a selection value for each content item of the plurality of first content items and the second plurality of content items based on at least one of the first interaction rate and the second interaction rate; and
selecting, by the data processing system, the content item from the first plurality of content items and the second plurality of content items based on a corresponding plurality of selection values in accordance with the content selection protocol.

8. The method of claim 1, wherein receiving the request further comprises receiving a query via a search engine accessed via an application executing on the client device, the query including the one or more keywords; and
wherein providing the content item further comprises providing the content item in the content slot of the information resource and search results for the query as primary content on the information resource for presentation via the application.

9. The method of claim 1, further comprising:
receiving, by the data processing system, a second request from a second client device, the second request identifying one or more second keywords in the first language, the second client device associated with the location identifier;
determining, by the data processing system, that the second client device uses the first language and does not use the second language identified as associated with the location identifier based on a plurality of previous requests from the second client device;
and identifying, by the data processing system, a third plurality of content items in the first language without any content items in the second language.

10. The method of claim 1, further comprising:
receiving, by the data processing system, prior to the request, a second request from the client device, the second request including one or more second keywords in the second language;
determining, by the data processing system, the second language based on the one or more second keywords; and
identifying, by the data processing system, responsive to determining the second language, a third plurality of content items in the second language without identifying any content items in the first language.

11. A system for selecting content to provide in networked environments, comprising:
a data processing system having one or more processors coupled with memory, configured to:
receive, from a client device, a request for content to insert into a content slot of an information resource, the request including one or more keywords in a first language;
determine the first language based on the one or more keywords of the request and requests received prior to the request;
determine, using the request, a location identifier identifying a location of the client device;
identify a second language associated with the location identifier, the second language different from the first language;
determine that the client device uses both the first language and the second language;
identify a first plurality of content items in the first language and a second plurality of content items in the second language based on the one or more keywords of the request in the first language, responsive to determining that both the first language and the second language are used on the client device; and
select a content item from one of the first plurality of content items and the second plurality of content items in accordance with a content selection protocol; and provide the content item to the client device to insert into the content slot of the information resource.

12. The system of claim 11, wherein the data processing system is further configured to: identify a second request from the client device, the second request including one or more second keywords in accordance with the second language; and
determine, based on the one or more keywords of the request and the one or more second keywords of the second request, that the client device uses the first language and the second language.

13. The system of claim 11, wherein the data processing system is further configured to: generate, responsive to determining that the client device uses the first language and the second language, one or more second keywords in the second language based on the one or more keywords in the first language;
identify the first plurality of content items using the one or more keywords in the first language, and identify the second plurality of content items using the one or more second keywords in the second language.

14. The system of claim 11, wherein the data processing system is further configured to: identify, from a log record, a plurality of inputs from a plurality of client devices, each of the plurality of inputs having one or more second keywords in the second language, each of the plurality of client devices associated with the location identifier matching the location identifier for the client device; and
determine the second language based on the one or more second keywords from each of the plurality of inputs.

15. The system of claim 11, wherein the data processing system is further configured to:
determine that the first language determined from the one or more keywords of the request differs from the second language associated with the location identifier of the request; and
identify the first plurality of the content items and the second plurality of content items responsive to determining that the first language differs from the second language.

16. The system of claim 11, wherein the data processing system is further configured to:
generate a selection value for each content item of the plurality of first content items and the second plurality of content items based on comparison of a language of the content item and the first language determined from the request; and
select the content item from the first plurality of content items and the second plurality of content items based on a corresponding plurality of selection values in accordance with the content selection protocol.

17. The system of claim 11, wherein the data processing system is further configured to:
determine, using a log record for the client device, a first interaction rate with content items in the first language and a second interaction rate with content items in the second language;
generate a selection value for each content item of the plurality of first content items and the second plurality of content items based on at least one of the first interaction rate and the second interaction rate; and
select the content item from the first plurality of content items and the second plurality of content items based on a corresponding plurality of selection values in accordance with the content selection protocol.

18. The system of claim 11, wherein the data processing system is further configured to:
receive a query via a search engine accessed via an application executing on the client device, the query including the one or more keywords; and
provide the content item in the content slot of the information resource and search results for the query as primary content on the information resource f for presentation via the application.

19. The system of claim 11, wherein the data processing system is further configured to: receive a second request from a second client device, the second request identifying one or more second keywords in the first language, the second client device associated with the location identifier;
determine that the second client device uses the first language and does not use the second language identified as associated with the location identifier based on a plurality of previous requests from the second client device; and
identify a third plurality of content items in the first language without any content items in the second language.

20. The system of claim 11, wherein the data processing system is further configured to: receive, prior to the input, a second request from the client device, the second request including one or more second keywords in the second language;
determine the second language based on the one or more second keywords; and
identify, responsive to determining the second language, a third plurality of content items in the second language without identifying any content items in the first language.

21. The system of claim 11, wherein receiving the query via the search engine accessed via the application executing on the client device includes receiving audio input via the search engine accessed via the application executing on the client device, and wherein the data processing system is further configured to:
convert, using a speech recognition model, the audio input into a set of alphanumeric characters to be used as the one or more keywords of the query.

22. The system of claim 21, wherein the data processing system is further configured to:
train the speech recognition model to identify keywords based on audio input.

23. The system of claim 21, wherein the speech recognition model is a natural language processing (NLP) model.

24. The system of claim 11, wherein determining, using the request, the location identifier identifying the location of the client device includes determining the location identifier by applying a machine learning model to the one or more keywords of the request.

25. The system of claim 24, wherein the data processing system is further configured to:
train the machine learning model to recognize keywords associated with geographic regions.

26. The system of claim 24, wherein the machine learning model is a natural language processing (NLP) model.

27. The system of claim 11, wherein determining the first language based on the one or more keywords of the request and the requests received prior to the request includes applying a language recognition machine learning model to the one or more keywords of the request and the requests received prior to the request.

28. The system of claim 27, wherein the data processing system is further configured to:
train the language recognition machine learning model to identify a language in which a text is written using a training dataset including one or more corpuses of text labeled with respective languages in which the respective corpuses are written.

29. The system of claim 28, wherein training the language recognition machine learning model includes:
applying the language recognition machine learning model to the text from one of the corpuses of text of the training dataset to generate a result language corresponding to one of the languages in which the respective corpuses are written;
comparing the result language to the language in which the corpus of text, to which the language recognition machine learning model was applied, was written;
determining an error associated with the language recognition machine learning model based on the comparison; and
modifying one or more weights associated with the language recognition machine learning model based on the determined error.

30. The system of claim 11, wherein identifying the second plurality of content items in the second language based on the one or more keywords in the first language includes:
applying a translation machine learning model to the one or more keywords in the first language to generate one or more keywords in the second language;
and identifying second plurality of content items in the second language based on the generated one or more keywords in the second language.

31. The system of claim 30, wherein the data processing system is further configured to:
train the translation machine learning model to generate one or more keywords in the second language based on one or more keywords in the first language, using a training dataset including one or more corpuses of text written in different languages, wherein one or more pairs of the one or more corpuses of text are labeled as translations of one another.

32. The system of claim 31, wherein training the translation machine learning model includes:
applying the translation machine learning model to a first corpus of text of a pair, of the one or more pairs of corpuses of text, to generate a result translated corpus of text;
comparing the result translated corpus of text to a second corpus of text of the pair, wherein the second corpus of text of the pair is a translation of the first corpus of text of the pair;
determining an error associated with the translation machine learning model based on the comparison; and
modifying one or more parameters associated with the translation machine learning model based on the determined error.
